(19) United States
(12) Patent Application Publication
(10) Pub. No.: US 2024/0338505 A1
(43) Pub. Date: Oct. 10, 2024

(54) INTEGRATED CIRCUIT GENERATION WITH COMPOSABLE INTERCONNECT

(71) Applicant: SiFive, Inc., Santa Clara, CA (US)

(72) Inventors: Robert P. Adler, Santa Clara, CA (US); Ryan Macdonald, San Mateo, CA (US); Asmit De, San Mateo, CA (US); Henry Cook, Berkeley, CA (US)

(73) Assignee: SiFive, Inc., Santa Clara, CA (US)

(21) Appl. No.: 18/747,403

(22) Filed: Jun. 18, 2024

Related U.S. Application Data
(63) Continuation of application No. PCT/US2022/053121, filed on Dec. 16, 2022.
(60) Provisional application No. 63/292,907, filed on Dec. 22, 2021.

(51) Int. Cl. G06F 30/337; G06F 13/40

(52) U.S. Cl. CPC G06F 30/337; G06F 13/40

(57) ABSTRACT

Disclosed are systems and methods that include integrated circuit generation with composable interconnect. In some implementations, a system may access a design parameters data structure that specifies an interconnect topology to be included in an integrated circuit. The system may invoke an integrated circuit design generator that applies the design parameters data structure, including with the interconnect topology. In some implementations, the design parameters data structure may specify a definition for a hardware object (e.g., the interconnect topology) and instances of the hardware object. The definition and the instances may each be modifiable. The system may invoke the generator to apply the design parameters data structure to generate the design.

### CROSS-REFERENCES TO RELATED APPLICATIONS

This application is a continuation of International Application No. PCT/US2022/053121, filed Dec. 16, 2022, which claims priority to U.S. Provisional Application No. 63/292,907, filed Dec. 22, 2021, the entire contents of which are incorporated herein by reference for all purposes.

### FIELD OF TECHNOLOGY

This disclosure relates generally to integrated circuits, and more specifically, to integrated circuit generation with composable interconnect.

### BACKGROUND

Integrated circuits may be designed and tested in a multi-step process that involves multiple specialized engineers performing a variety of different design and verification tasks on an integrated circuit design. A variety of internal or proprietary (e.g., company-specific) integrated circuit design tool chains may be used by these engineers to handle different parts of the integrated circuit design workflow of using commercial electronic design automation (EDA) tools.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a block diagram of an example of a system for facilitating generation and manufacture of integrated circuits.

FIG. 2 is a block diagram of an example of a system for facilitating generation of integrated circuits.

FIG. 3 is a flow chart of an example of a process for facilitating integrated circuit generation with composable interconnect.

FIG. 4 is another flow chart of an example of a process for facilitating integrated circuit generation with composable interconnect.

FIG. 5 is a block diagram of an example of a physical design of an integrated circuit.

FIG. 6 is a block diagram of another example of a physical design of an integrated circuit.

FIG. 7 is a block diagram of an example of an integrated circuit design with composable interconnect.

FIG. 8 is a block diagram of another example of an integrated circuit design with composable interconnect.

FIG. 9 is a block diagram of an example of a design parameters data structure.

FIG. 10 is a block diagram of an example of a hierarchy that may be implemented by a design parameters data structure.

### DETAILED DESCRIPTION

Automated generation of integrated circuit designs permits a chip configuration of an application-specific integrated circuit (ASIC) or a system on a chip (SoC) to be specified in terms of design parameters (or colloquially knobs). The design parameters may be captured in an input file, such as a JavaScript Object Notation (JSON) file. A system may automate the operation of tools, such as an integrated circuit design generator (or simply “generator”), that applies the design parameters to generate the integrated circuit design. The generator may express the functional operation of one or more hardware components (e.g., processor cores and caches) in a Hardware Construction Language (HCL) program. Such a program may be executed to produce instance(s) of the one or more components as a register transfer level (RTL) output. Such a program may be capable of producing many different permutations of the one or more components by making allowances for changing the number of and characteristics of elements of the one or more components based on the design parameters. For example, a system may use Chisel, an open source tool for hardware construction embedded in the Scala programming language, to execute a Scala program that applies the design parameters to generate an integrated circuit design in a flexible intermediate representation for register-transfer level (FIRRTL) data structure.

Design parameters may configure the quantity and/or characteristics of hardware components (e.g., processor cores and caches) to be included an integrated circuit design. The design parameters may specify each component to be included. The generator (e.g., the Scala program) may apply the design parameters (e.g., the JSON file) by instantiating the components in the design with an interconnect topology that is determined by the generator. The interconnect topology (or “fabric”) may comprise circuitry in the design that is configured to receive a transaction (e.g., read and/or write request(s)) from a source (e.g., a transaction source, such as a processor core); decode an address associated with the transaction; and route the transaction to a sink (e.g., a transaction sink, such as a shared resource, such as a cache or other memory). For example, the interconnect topology may comprise a cross bar. Accordingly, the interconnect topology may be specified in the design to route transactions between hardware (e.g., between a processor core and a cache).

It may be desirable to change the interconnect topology for a design, such as to optimize the interconnect topology for a particular physical design that may be implemented on the chip (e.g., a floor plan). For example, it may be desirable for an interconnect topology to have greater or fewer transaction repeaters (e.g., repeater flops, protocol buffers, or pipeline stages) between hardware (e.g., between processor cores and a shared cache) based on the physical locations of the hardware on the chip. While the generator could be modified to include one or more additional interconnect topologies, this could possibly complicate the generator by having to account for multiple possibilities.

Described herein are techniques which permit changing an interconnect topology implemented in an integrated circuit design. A system may access a design parameters data structure (e.g., a JSON file) (e.g., a design specification). The design parameters data structure may comprise design parameters (or colloquially knobs) that specify an interconnect topology (e.g., a first interconnect topology comprising text, specified as an object in a JSON file, which may further specify hardware connections for components that are attached to the interconnect) to be included in an integrated circuit (e.g., chip). The interconnect topology may be designed to receive a transaction (e.g., read and/or write request(s)) from a source (e.g., a processor core); decode an address associated with the transaction; and route the transaction to a sink (e.g., a shared resource, such as memory). The system may invoke an integrated circuit design generator (or simply “generator”) (e.g., a Scala program) that applies the design parameters data structure (e.g., executes to produce instance(s) of the hardware) to generate the integrated circuit design (e.g., a FIRRTL data structure or an RTL data structure).

The generator may implement a second interconnect topology (e.g., a generator-specific interconnect topology, or default interconnect topology) to be included in the integrated circuit. The second interconnect topology may also be designed to receive a transaction (e.g., read and/or write request(s)) from a source (e.g., a processor core); decode an address associated with the transaction; and route the transaction to a sink (e.g., a shared resource, such as memory). The second interconnect topology (e.g., generator-specific interconnect topology) may be different than the first interconnect topology comprising the text, such as one topology having greater or fewer transaction repeaters than the other. The generator may apply the design parameters data structure so that the second interconnect topology (e.g., generator-specific interconnect topology) is changed based on the first interconnect topology comprising the text (e.g., the interconnect hardware is changed, including connections attached to the interconnect hardware).

In some implementations, the generator may apply the design parameters data structure to append the first interconnect topology comprising the text to the second interconnect topology (e.g., generator-specific interconnect topology). In some implementations, the generator may apply the design parameters data structure to replace the second interconnect topology (e.g., generator-specific interconnect topology) with the first interconnect topology comprising the text. In some implementations, the generator may apply the design parameters data structure so that components in the design are updated to attach to the first interconnect topology. Thus, the interconnect topology may be changed without modifying the generator. This may permit optimizing the interconnect topology for a particular physical design that may be implemented on a chip.

Additionally, it may be desirable to change the hardware components (e.g., processor cores and caches) that are specified by the design parameters. For example, to implement the hardware in an SoC, it may be desirable to change one or more components to include information that is specific to the SoC, such as addresses associated with registers that are visible in software (e.g., a base address) and/or identifiers associated with the hardware (e.g., a hardware thread (HART) identifier) when implemented on the chip. While the hardware components in the design parameters data structure may be changed individually, there may be many such components specified in the design. This may limit the ability to review and/or modify the design parameters.

Also described herein are techniques which improve changing the hardware components in a design parameters data structure used for a design. A system may access a design parameters data structure (e.g., a JSON file). The design parameters data structure may comprise design parameters (or colloquially knobs) that specify one or more definitions for a hardware object (e.g., an interconnect topology, a processor core, a cache, or a cluster, specified as an object in the JSON file) and instances of the hardware object (e.g., instances of the interconnect topology, the processor core, the cache, or the cluster, specified as instances of the object in the JSON file). Modifying the one or more definitions for the hardware object in the design parameters data structure may permit modification of the instances of the hardware object (e.g., overriding the instances with the modification to the definition), such as when the generator executes to apply the design parameters data structure. Additionally, values or parameters of individual instances can be modified, such as to include information that is specific to an SoC implementation (e.g., a value that indicates one or more addresses associated with the instance when implemented on the SoC, such as an address for routing a memory transaction, and/or a value that indicates an identifier for the instance when implemented on the SoC, such as a central processing unit (CPU) identifier). Thus, the definition and the instances may each be modifiable. The system may invoke the generator that applies the design parameters data structure (e.g., executes to produce the instance(s) of the hardware in the design) to generate the integrated circuit design (e.g., RTL data structure). Thus, hardware in the design parameters data structure may be efficiently changed and implemented in the design.

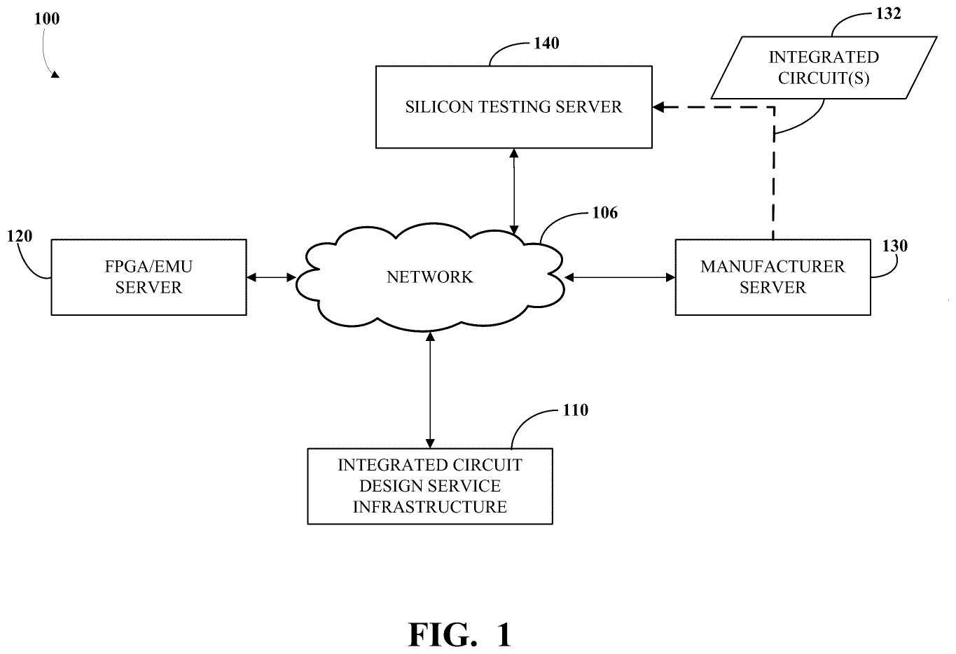

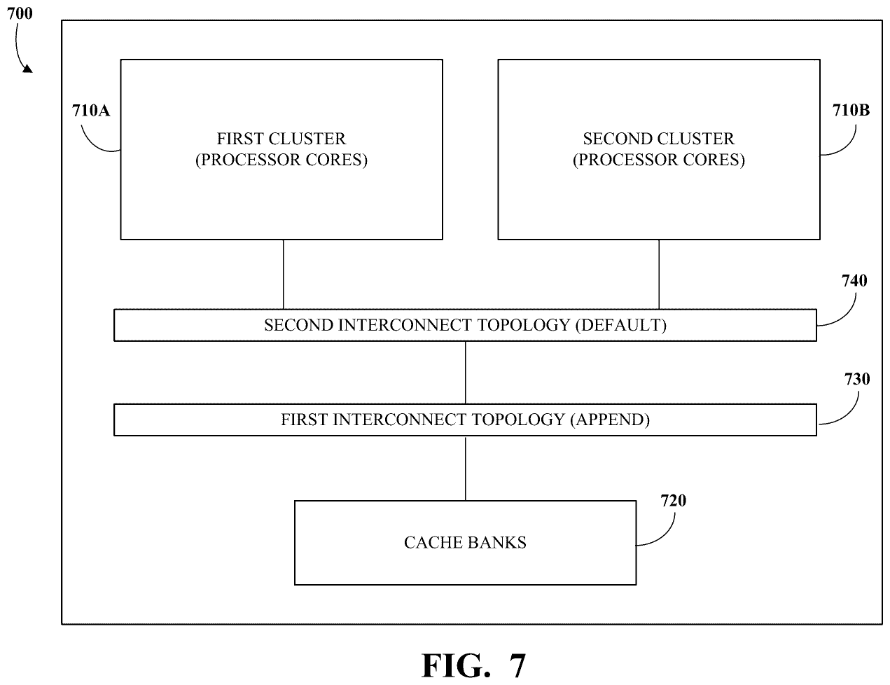

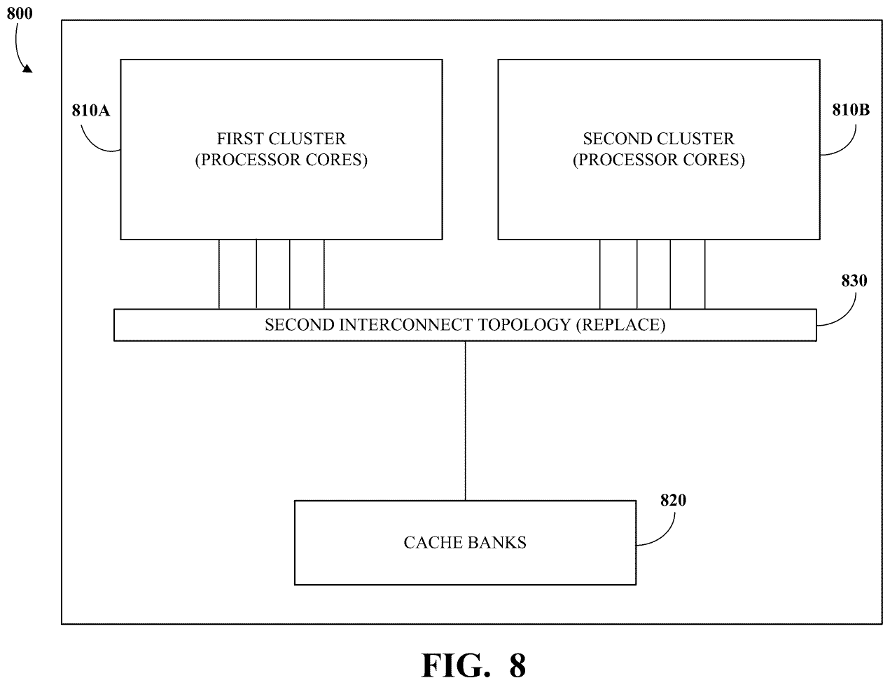

FIG. 1 is a block diagram of an example of a system 100 for generation and manufacture of integrated circuits having composable interconnect. The system 100 includes a network 106, an integrated circuit design service infrastructure 110, a field programmable gate array (FPGA)/emulator server 120, and a manufacturer server 130. For example, a user may utilize a web client or a scripting application program interface (API) client to command the integrated circuit design service infrastructure 110 to automatically generate an integrated circuit design based on a set of design parameter values selected by the user for one or more template integrated circuit designs. In some implementations, the integrated circuit design service infrastructure 110 may be configured to generate an integrated circuit design with composable interconnect like the integrated circuit design 700 shown in FIG. 7 and/or the integrated circuit design 800 shown in FIG. 8.

The integrated circuit design service infrastructure 110 may include a register-transfer level (RTL) service module configured to generate an RTL data structure for the integrated circuit based on a design parameters data structure. For example, the RTL service module may be implemented as Scala code. For example, the RTL service module may be implemented using Chisel (available at https://people.eecs.berkeley.edu/˜jrb/papers/chisel-dac-2012-corrected.pdf). For example, the RTL service module may be implemented using FIRRTL (flexible intermediate representation for register-transfer level) (available at https://aspire.eecs.berkeley.edu/wp/wp-content/uploads/2017/11/Specification-for-the-FIRRTL-Language-Izraelevitz.pdf). For example, the RTL service module may be implemented using Diplomacy (available at https://carrv.github.io/2017/papers/cook-diplomacy-carrv2017.pdf). For example, the RTL service module may enable a well-designed chip to be automatically developed from a high level set of configuration settings using a mix of Diplomacy, Chisel, and FIRRTL. The RTL service module may take the design parameters data structure (e.g., a java script object notation (JSON) file) as input and output an RTL data structure (e.g., a Verilog file) for the chip.

In some implementations, the integrated circuit design service infrastructure 110 may invoke (e.g., via network communications over the network 106) testing of the resulting design that is performed by the FPGA/emulation server 120 that is running one or more FPGAs or other types of hardware or software emulators. For example, the integrated circuit design service infrastructure 110 may invoke a test using a field programmable gate array, programmed based on a field programmable gate array emulation data structure, to obtain an emulation result. The field programmable gate array may be operating on the FPGA/emulation server 120, which may be a cloud server. Test results may be returned by the FPGA/emulation server 120 to the integrated circuit design service infrastructure 110 and relayed in a useful format to the user (e.g., via a web client or a scripting API client).

The integrated circuit design service infrastructure 110 may also facilitate the manufacture of integrated circuits using the integrated circuit design in a manufacturing facility associated with the manufacturer server 130. In some implementations, a physical design specification (e.g., a graphic data system (GDS) file, such as a GDSII file) based on a physical design data structure for the integrated circuit is transmitted to the manufacturer server 130 to invoke manufacturing of the integrated circuit (e.g., using manufacturing equipment of the associated manufacturer). For example, the manufacturer server 130 may host a foundry tape-out website that is configured to receive physical design specifications (e.g., such as a GDSII file or an open artwork system interchange standard (OASIS) file) to schedule or otherwise facilitate fabrication of integrated circuits. In some implementations, the integrated circuit design service infrastructure 110 supports multi-tenancy to allow multiple integrated circuit designs (e.g., from one or more users) to share fixed costs of manufacturing (e.g., reticle/mask generation, and/or shuttles wafer tests). For example, the integrated circuit design service infrastructure 110 may use a fixed package (e.g., a quasi-standardized packaging) that is defined to reduce fixed costs and facilitate sharing of reticle/mask, wafer test, and other fixed manufacturing costs. For example, the physical design specification may include one or more physical designs from one or more respective physical design data structures in order to facilitate multi-tenancy manufacturing.

In response to the transmission of the physical design specification, the manufacturer associated with the manufacturer server 130 may fabricate and/or test integrated circuits based on the integrated circuit design. For example, the associated manufacturer (e.g., a foundry) may perform optical proximity correction (OPC) and similar post-tape-out/pre-production processing, fabricate the integrated circuit(s) 132, update the integrated circuit design service infrastructure 110 (e.g., via communications with a controller or a web application server) periodically or asynchronously on the status of the manufacturing process, perform appropriate testing (e.g., wafer testing), and send to a packaging house for packaging. A packaging house may receive the finished wafers or dice from the manufacturer and test materials and update the integrated circuit design service infrastructure 110 on the status of the packaging and delivery process periodically or asynchronously. In some implementations, status updates may be relayed to the user when the user checks in using the web interface, and/or the controller might email the user that updates are available.

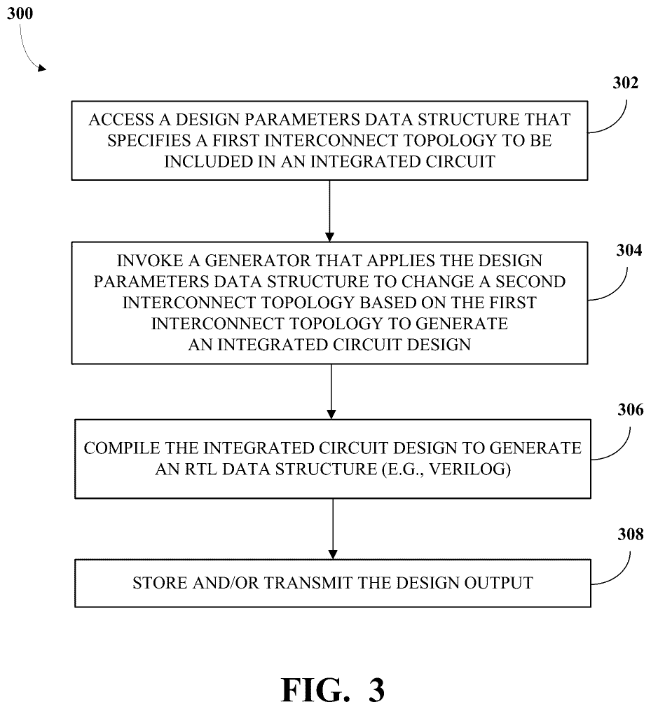

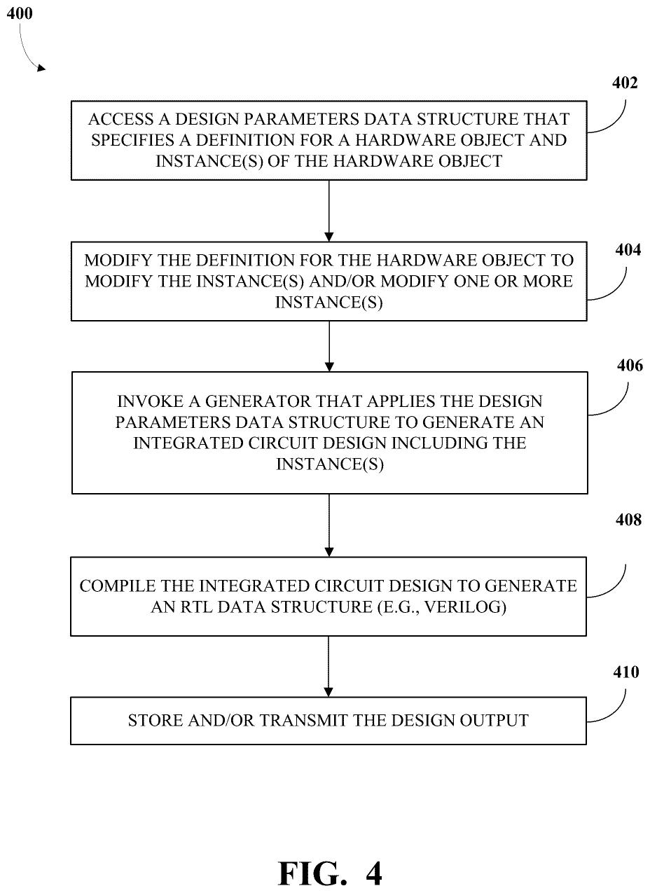

In some implementations, the resulting integrated circuit(s) 132 (e.g., physical chips) are delivered (e.g., via mail) to a silicon testing service provider associated with a silicon testing server 140. In some implementations, the resulting integrated circuit(s) 132 (e.g., physical chips) are installed in a system controlled by the silicon testing server 140 (e.g., a cloud server), making them quickly accessible to be run and tested remotely using network communications to control the operation of the integrated circuit(s) 132. For example, a login to the silicon testing server 140 controlling a manufactured integrated circuit(s) 132 may be sent to the integrated circuit design service infrastructure 110 and relayed to a user (e.g., via a web client). For example, the integrated circuit design service infrastructure 110 may be used to control testing of one or more integrated circuit(s) 132, which may be structured based on a design determined using the process 300 shown in FIG. 3 and/or the process 400 shown in FIG. 4.

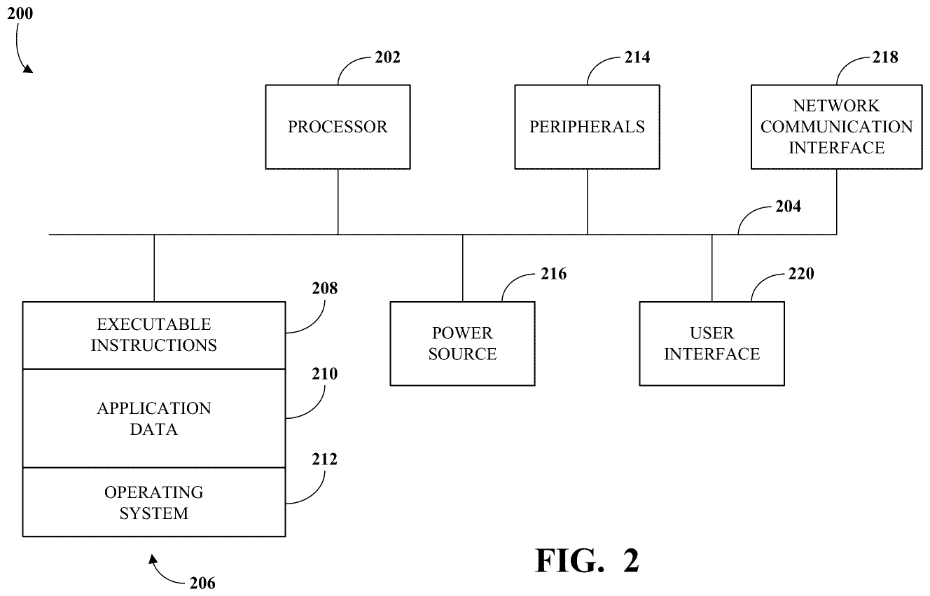

FIG. 2 is a block diagram of an example of a system 200 for facilitating generation of integrated circuits having composable interconnect, for facilitating generation of a circuit representation for an integrated circuit, and/or for programming or manufacturing an integrated circuit. The system 200 is an example of an internal configuration of a computing device that may be used to implement the integrated circuit design service infrastructure 110, and/or to generate a file that generates a circuit representation of an integrated circuit design like the integrated circuit design 700 shown in FIG. 7 and/or the integrated circuit design 800 shown in FIG. 8. The system 200 can include components or units, such as a processor 202, a bus 204, a memory 206, peripherals 214, a power source 216, a network communication interface 218, a user interface 220, other suitable components, or a combination thereof.

The processor 202 can be a central processing unit (CPU), such as a microprocessor, and can include single or multiple processors having single or multiple processing cores. Alternatively, the processor 202 can include another type of device, or multiple devices, now existing or hereafter developed, capable of manipulating or processing information. For example, the processor 202 can include multiple processors interconnected in any manner, including hardwired or networked, including wirelessly networked. In some implementations, the operations of the processor 202 can be distributed across multiple physical devices or units that can be coupled directly or across a local area or other suitable type of network. In some implementations, the processor 202 can include a cache, or cache memory, for local storage of operating data or instructions.

The memory 206 can include volatile memory, non-volatile memory, or a combination thereof. For example, the memory 206 can include volatile memory, such as one or more dynamic random access memory (DRAM) modules such as double data rate (DDR) synchronous DRAM (SDRAM), and non-volatile memory, such as a disk drive, a solid-state drive, flash memory, Phase-Change Memory (PCM), or any form of non-volatile memory capable of persistent electronic information storage, such as in the absence of an active power supply. The memory 206 can include another type of device, or multiple devices, now existing or hereafter developed, capable of storing data or instructions for processing by the processor 202. The processor 202 can access or manipulate data in the memory 206 via the bus 204. Although shown as a single block in FIG. 2, the memory 206 can be implemented as multiple units. For example, a system 200 can include volatile memory, such as random access memory (RAM), and persistent memory, such as a hard drive or other storage.

The memory 206 can include executable instructions 208, data, such as application data 210, an operating system 212, or a combination thereof, for immediate access by the processor 202. The executable instructions 208 can include, for example, one or more application programs, which can be loaded or copied, in whole or in part, from non-volatile memory to volatile memory to be executed by the processor 202. The executable instructions 208 can be organized into programmable modules or algorithms, functional programs, codes, code segments, or combinations thereof to perform various functions described herein. For example, the executable instructions 208 can include instructions executable by the processor 202 to cause the system 200 to automatically, in response to a command, generate an integrated circuit design and associated test results based on a design parameters data structure. The application data 210 can include, for example, user files, database catalogs or dictionaries, configuration information or functional programs, such as a web browser, a web server, a database server, or a combination thereof. The operating system 212 can be, for example, Microsoft Windows®, macOS®, or Linux®; an operating system for a small device, such as a smartphone or tablet device; or an operating system for a large device, such as a mainframe computer. The memory 206 can comprise one or more devices and can utilize one or more types of storage, such as solid-state or magnetic storage.

The peripherals 214 can be coupled to the processor 202 via the bus 204. The peripherals 214 can be sensors or detectors, or devices containing any number of sensors or detectors, which can monitor the system 200 itself or the environment around the system 200. For example, a system 200 can contain a temperature sensor for measuring temperatures of components of the system 200, such as the processor 202. Other sensors or detectors can be used with the system 200, as can be contemplated. In some implementations, the power source 216 can be a battery, and the system 200 can operate independently of an external power distribution system. Any of the components of the system 200, such as the peripherals 214 or the power source 216, can communicate with the processor 202 via the bus 204.

The network communication interface 218 can also be coupled to the processor 202 via the bus 204. In some implementations, the network communication interface 218 can comprise one or more transceivers. The network communication interface 218 can, for example, provide a connection or link to a network, such as the network 106 shown in FIG. 1, via a network interface, which can be a wired network interface, such as Ethernet, or a wireless network interface. For example, the system 200 can communicate with other devices via the network communication interface 218 and the network interface using one or more network protocols, such as Ethernet, transmission control protocol (TCP), Internet protocol (IP), power line communication (PLC), wireless fidelity (Wi-Fi), infrared, general packet radio service (GPRS), global system for mobile communications (GSM), code division multiple access (CDMA), or other suitable protocols.

A user interface 220 can include a display; a positional input device, such as a mouse, touchpad, touchscreen, or the like; a keyboard; or other suitable human or machine interface devices. The user interface 220 can be coupled to the processor 202 via the bus 204. Other interface devices that permit a user to program or otherwise use the system 200 can be provided in addition to or as an alternative to a display. In some implementations, the user interface 220 can include a display, which can be a liquid crystal display (LCD), a cathode-ray tube (CRT), a light emitting diode (LED) display (e.g., an organic light emitting diode (OLED) display), or other suitable display. In some implementations, a client or server can omit the peripherals 214. The operations of the processor 202 can be distributed across multiple clients or servers, which can be coupled directly or across a local area or other suitable type of network. The memory 206 can be distributed across multiple clients or servers, such as network-based memory or memory in multiple clients or servers performing the operations of clients or servers. Although depicted here as a single bus, the bus 204 can be composed of multiple buses, which can be connected to one another through various bridges, controllers, or adapters.

A non-transitory computer readable medium may store a circuit representation that, when processed by a computer, is used to program or manufacture an integrated circuit. For example, the circuit representation may describe the integrated circuit specified using a computer readable syntax. The computer readable syntax may specify the structure or function of the integrated circuit or a combination thereof. In some implementations, the circuit representation may take the form of a hardware description language (HDL) program, a register-transfer level (RTL) data structure, a flexible intermediate representation for register-transfer level (FIRRTL) data structure, a Graphic Design System II (GDSII) data structure, a netlist, or a combination thereof. In some implementations, the integrated circuit may take the form of a field programmable gate array (FPGA), application specific integrated circuit (ASIC), system-on-a-chip (SoC), or some combination thereof. A computer may process the circuit representation in order to program or manufacture an integrated circuit, which may include programming a field programmable gate array (FPGA) or manufacturing an application specific integrated circuit (ASIC) or a system on a chip (SoC). In some implementations, the circuit representation may comprise a file that, when processed by a computer, may generate a new description of the integrated circuit. For example, the circuit representation could be written in a language such as Chisel, an HDL embedded in Scala, a statically typed general purpose programming language that supports both object-oriented programming and functional programming.

In an example, a circuit representation may be a Chisel language program which may be executed by the computer to produce a circuit representation expressed in a FIRRTL data structure. In some implementations, a design flow of processing steps may be utilized to process the circuit representation into one or more intermediate circuit representations followed by a final circuit representation which is then used to program or manufacture an integrated circuit. In one example, a circuit representation in the form of a Chisel program may be stored on a non-transitory computer readable medium and may be processed by a computer to produce a FIRRTL circuit representation. The FIRRTL circuit representation may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit.

In another example, a circuit representation in the form of Verilog or VHDL may be stored on a non-transitory computer readable medium and may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. The foregoing steps may be executed by the same computer, different computers, or some combination thereof, depending on the implementation.

FIG. 3 is a flow chart of an example of a process 300 for facilitating integrated circuit generation with composable interconnect. The process 300 may include accessing 302 a design parameters data structure that specifies a first interconnect topology comprising text; invoking 304 an integrated circuit design generator that applies the design parameters data structure; compiling 306 the integrated circuit design to generate an RTL data structure such as Verilog; and/or storing and/or transmitting 308 the integrated circuit design. For example, the process 300 may be implemented using the system 100 shown in FIG. 1 and/or the system 200 shown in FIG. 2. For example, the process 300 may be implemented, at least in part, to generate the integrated circuit design 700 shown in FIG. 7 and/or the integrated circuit design 800 shown in FIG. 8. For example, the process 300 may be implemented, at least in part, using the design parameters data structure 800 shown in FIG. 8.

The process 300 may include accessing 302 a machine readable design parameters data structure (e.g., a JSON file). In some implementations, a system like the integrated circuit design service infrastructure 110 shown in FIG. 1 may execute to access the design parameters data structure. In some implementations, the system may execute to compose the design parameters data structure. The design parameters data structure may comprise design parameters that specify a first interconnect topology comprising text (e.g., specified as an object in the JSON file) to be included in an integrated circuit. In some implementations, the first interconnect topology comprising the text may be selected from a library. The first interconnect topology comprising the text may be specified as an object having hardware connections. The first interconnect topology comprising the text may be designed to receive a transaction (e.g., read and/or write request(s)) from a source (e.g., a processor core); decode an address associated with the transaction; and route the transaction to a sink (e.g., a shared resource, such as memory, such as a shared Level 3 (L3) cache), in an integrated circuit. For example, the first interconnect topology comprising the text may comprise as a cross bar.

In some implementations, the design parameters data structure may specify one or more definitions for a hardware object (e.g., the first interconnect topology) and instances of the hardware object (e.g., instances of the first interconnect topology). Modifying the one or more definitions for the hardware object in the design parameters data structure may permit modification of the instances (e.g., overriding the instances via the modification to the definition). Additionally, values or parameters of individual instances can be modified, such as to include information that is specific to an SoC implementation (e.g., a value that indicates one or more addresses associated with the instance when implemented on the SoC, such as an address for routing a memory transaction, and/or a value that indicates an identifier for the instance when implemented on the SoC, such as a central processing unit (CPU) identifier). Thus, the definition and the instances may each be modifiable.

The process 300 may also include invoking 304 an integrated circuit design generator (“generator”) (e.g., a Scala program) that applies the design parameters data structure (e.g., executes to produce instance(s) of the hardware) to generate the integrated circuit design (e.g., a FIRRTL data structure or an RTL data structure). The generator may implement a second interconnect topology (e.g., a generator-specific interconnect topology, or default interconnect topology) to be included in the integrated circuit. The second interconnect topology may also be designed to receive a transaction (e.g., read and/or write request(s)) from a source (e.g., a processor core); decode an address associated with the transaction; and route the transaction to a sink (e.g., a shared resource, such as memory, such as a shared L3 cache), in an integrated circuit. The second interconnect topology may be different than the first interconnect topology comprising the text, such one topology having greater or fewer transaction repeaters than the other (e.g., between the processor cores and the L3 cache). The generator may apply the design parameters data structure so that the second interconnect topology is changed (e.g., appended or replaced) based on the first interconnect topology comprising the text.

Thus, the interconnect topology may be changed without modifying the generator. This may permit optimizing the interconnect topology for a particular physical design that may be implemented (e.g., floor plan). In some implementations, the generator may express a functional operation of the hardware components (e.g., interconnect topology, processor core, cache) in a Hardware Construction Language (HCL) program. For example, the generator may take the design parameters data structure (e.g., the JSON file) as input, execute Chisel to elaborate instances of the hardware components with the interconnect topology, and generate the design in a FIRRTL data structure or an RTL data structure. The design may express the integrated circuit design as synthesizable circuitry.

The process 300 may also include compiling 306 the integrated circuit design to generate an RTL data structure such as Verilog. For example, the integrated circuit design may be compiled using a FIRRTL compiler to generate Verilog. The design output may express the integrated circuit design as synthesizable circuitry in Verilog.

The process 300 may also include storing and/or transmitting 308 the RTL data structure compiled from the integrated circuit design. The RTL data structure may be stored for use in subsequent operations, such as synthesis, placement and routing, implementation of clock trees, and/or simulation analysis. Additionally, the RTL data structure may be transmitted for manufacturing of an integrated circuit, such as an ASIC or an SoC.

In some implementations, the generator may instantiate a bridge (e.g., a protocol bridge or adapter to enable communication) for routing transactions from a transaction source associated with a first protocol to a transaction sink associated with a second protocol. This may enable the interconnect topology to be a heterogenous topology (e.g., a topology associated with different protocols which may include differences in wiring or connections, names, and transaction rules or behaviors). For example, the transaction source could be implemented by TileLink, a chip-scale interconnect standard that provides multiple clients with coherent memory mapped access to memory and/or server devices, and the transaction sink could be implemented by TileLink 2c, a revision to TileLink involving cacheable memory at a shared address space using a protocol that is different from TileLink, or by the advanced extensible interface (AXI), such as AXI3 or AXI4, or the AXI coherency extensions (ACE), which are other communication bus protocols that may be used by components implemented by an integrated circuit. For example, the design parameters data structure may specify a transaction source associated with a first protocol and a transaction sink associated with a second protocol. As a result, the interconnect topology may be heterogenous (e.g., enabling communication between different types of protocols), and the generator can automatically derive and instantiate the bridges for the implementation. For example, the generator may instantiate a bridge when appending or replacing the interconnect topology. In some implementations, the bridge and the interconnect topology could be implemented by a cross bar having ports for enabling the heterogeneous communication. In some implementations, a bridge may include an address decoder and translation circuitry (e.g., a wrapper logic).

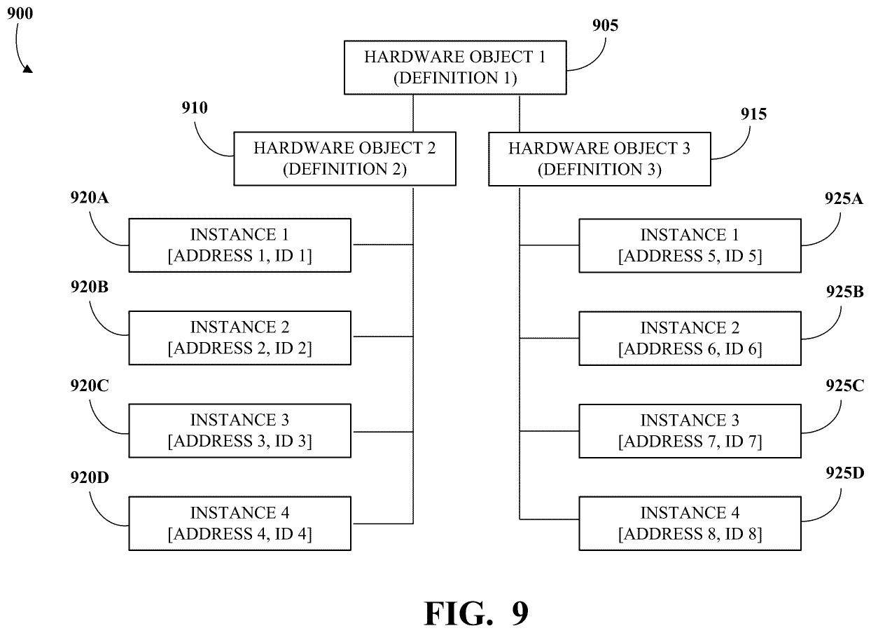

FIG. 4 is a flow chart of another example of a process 400 for facilitating integrated circuit generation with composable interconnect. The process 400 may include accessing 402 a design parameters data structure that specifies one or more definitions for a hardware object; modifying 404 the one or more definitions for the hardware object and/or instances of the hardware object; invoking 406 an integrated circuit design generator that applies the design parameters data structure; compiling 408 the integrated circuit design to generate an RTL data structure; and/or storing and/or transmitting 410 the integrated circuit design. For example, the process 400 may be implemented using the system 100 shown in FIG. 1 and/or the system 200 shown in FIG. 2. For example, the process 400 may be implemented, at least in part, to generate the integrated circuit design 700 shown in FIG. 7 and/or the integrated circuit design 800 shown in FIG. 8. For example, the process 400 may be implemented, at least in part, using the design parameters data structure 900 shown in FIG. 9.

The process 400 may include accessing 402 a design parameters data structure (e.g., a JSON file). In some implementations, a system like the integrated circuit design service infrastructure 110 shown in FIG. 1 may execute to access the design parameters data structure. In some implementations, the system may execute to compose the design parameters data structure. The design parameters data structure may comprise design parameters that specify one or more definitions for a hardware object (e.g., specified as an object in the JSON file) and instances of the hardware object (e.g., specified as instances of the object in the JSON file). For example, the design parameters data structure may comprise design parameters that specify a definition for an interconnect topology, a processor core, a cache, or a cluster (e.g., including processor cores and their private Level 2 (L2) caches). For example, the instances of the hardware object may be instances of the interconnect topology, the processor core, the cache, or the cluster. In some implementations, the design parameters data structure may specify a definition for a hardware object at multiple levels. For example, the design parameters data structure may specify a first definition for a hardware object, a second definition for the hardware object that falls within the first definition, and instances of the hardware object that fall within the first and second definitions.

The process 400 may also include modifying 404 the definition for the hardware object and/or instances of the hardware object. Modifying the definition for the hardware object in the design parameters data structure may permit modification of all of the instances of the hardware object (e.g., overriding the instances with the modification to the definition), such as when the generator executes to apply the design parameters data structure. Additionally, values or parameters of individual instances can be modified, such as to include information that is specific to an SoC implementation (e.g., a value that indicates one or more addresses associated with the instance when implemented on the SoC, such as an address for routing a memory transaction, and/or a value that indicates an identifier for the instance when implemented on the SoC, such as a central processing unit (CPU) identifier). Thus, the definition and the instances may each be modifiable. In some implementations, definitions for a hardware object may be modifiable at multiple levels. For example, the design parameters data structure may specify a first definition for a hardware object, a second definition for the hardware object that falls within the first definition, and instances of the hardware object that fall within the first and second definitions. Modifying the first definition may also modify the second definition and the instances. Modifying the second definition may also modify the instances, but not the first definition. The instances may be modified without affecting the first definition or the second definition.

The process 400 may also include invoking 406 an integrated circuit design generator. The generator may apply the design parameters data structure (e.g., executes to produce the instance(s) of the hardware in the design) to generate the integrated circuit design (e.g., a FIRRTL data structure or an RTL data structure), including with the instances of the hardware. In some implementations, the generator may express a functional operation of the hardware components (e.g., the interconnect topology, the processor core, the cache, or the cluster) in a Hardware Construction Language (HCL) program. For example, the generator may take the design parameters data structure (e.g., the JSON file) as input, execute Chisel to elaborate instances of the hardware components with the interconnect topology, and generate the design in a FIRRTL data structure. The design may express the integrated circuit design as synthesizable circuitry.

The process 400 may also include compiling 408 the integrated circuit design to generate an RTL data structure such as Verilog. For example, the integrated circuit design may be compiled using a FIRRTL compiler to generate Verilog. The design output may express the integrated circuit design as synthesizable circuitry in Verilog.

The process 400 may also include storing and/or transmitting 410 the RTL data structure compiled from the integrated circuit design. The RTL data structure may be stored for use in subsequent operations, such as synthesis, placement and routing, implementation of clock trees, and/or simulation analysis. Additionally, the RTL data structure may be transmitted for manufacturing of an integrated circuit, such as an ASIC or an SoC.

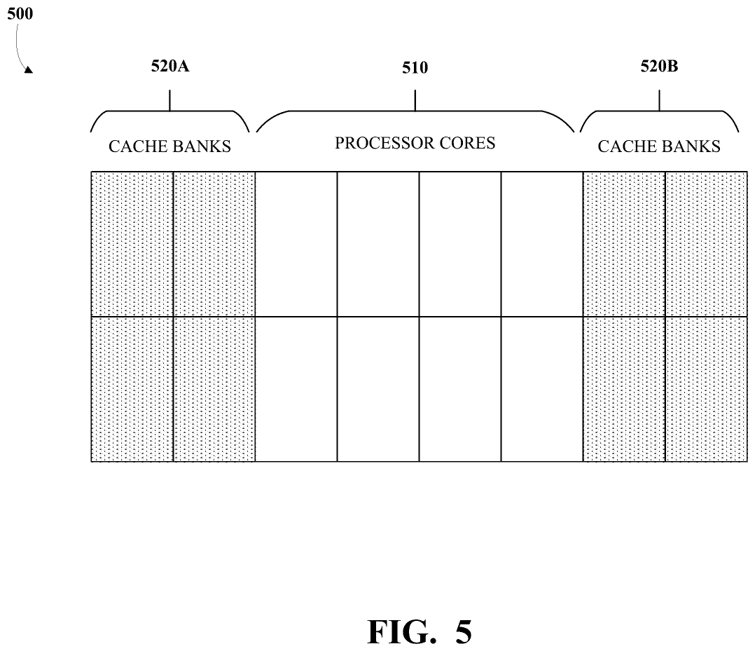

FIG. 5 is a block diagram of an example of a physical design 500 of an integrated circuit (e.g., a floor plan). For example, the physical design 500 may be selected for implementation of an integrated circuit (e.g., for the physical design of a chip). In some implementations, the physical design 500 may be selected by the integrated circuit design service infrastructure 110 shown in FIG. 1. The physical design 500 may include eight processor cores 510 (with each having a private L2 cache) and eight banks of shared L3 cache (e.g., a cache shared by the eight processor cores 510). The eight processor cores 510 may be arranged as two clusters in the middle of the chip (e.g., each cluster including four processor cores). The eight banks of shared L3 cache may be arranged on opposing sides of the chip, such as four banks 520A on a first side of the chip and four banks 520B on a second side of the chip opposing the first side (with the eight processor cores 510 in between the four banks 520A and the four banks 520B).

A design parameters data structure may specify an interconnect topology (e.g., a first interconnect topology comprising text) that is optimized for the physical design 500. For example, an interconnect topology that is optimized for the physical design 500 may have greater or fewer transaction repeaters (e.g., repeater flops, protocol buffers, or pipeline stages) between hardware (e.g., between the eight processor cores 510 and the eight banks of shared L3 cache) than a default interconnect topology provided by an integrated circuit design generator. In some implementations, optimizing the interconnect topology may reduce latency, such as by reducing the number of transaction repeaters. Accordingly, the integrated circuit design generator may apply the design parameters data structure so that the default interconnect topology that is provided by the generator is changed based on the interconnect topology specified in the design parameters data structure (e.g., the interconnect topology that is optimized for the physical design 500).

In some implementations, the integrated circuit may be heterogenous with respect to one or more components, such as one or more of the eight processor cores 510 and/or one or more of the eight banks of shared L3 cache. For example, one or more of the eight processor cores 510 and/or eight banks of shared L3 cache (e.g., four processor cores and the four banks 520A on the first side of the chip) could include logic for implementing a first protocol (e.g., TileLink), and another one or more of the eight processor cores 510 and/or eight banks of shared L3 cache (e.g., four processor cores and the four banks 520B on the second side of the chip) could include logic for implementing a second protocol (e.g., TileLink 2c or AXI). The components associated with the protocols may be specified by the design parameters data structure, and the generator, when applying the design parameters data structure, may instantiate one or more bridges to include logic with the interconnect topology for bridging between the components associated with the different protocols.

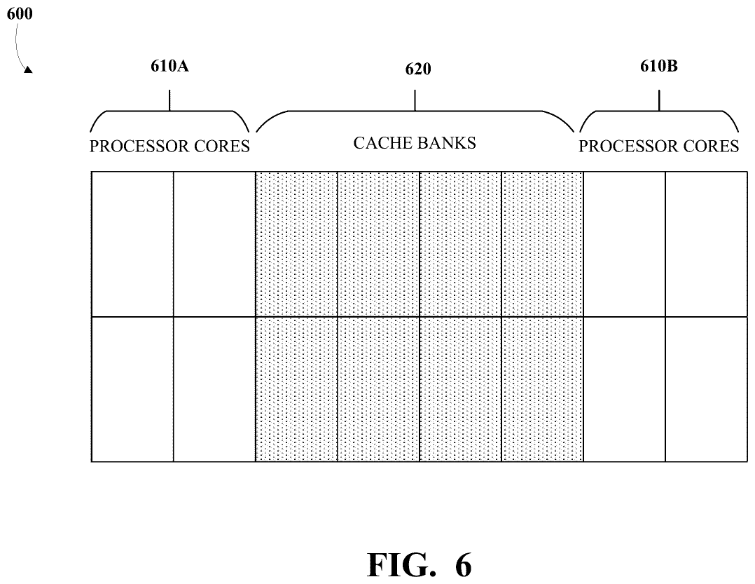

FIG. 6 is a block diagram of another example of a physical design 600 of an integrated circuit (e.g., a floor plan). For example, the physical design 600 may be selected for implementation of an integrated circuit (e.g., for the physical design of a chip). In some implementations, the physical design 600 may be selected by the integrated circuit design service infrastructure 110 shown in FIG. 1. The physical design 600 may include eight processor cores (with each having a private L2 cache) and eight banks 620 of shared L3 cache (e.g., a cache shared by the eight processor cores). The eight banks 620 may be arranged in the middle of the chip. The eight processor cores may be arranged on opposing sides of the chip, such as a first cluster 610A (comprising four processor cores) on a first side of the chip and a second cluster 610B (comprising four processor cores) on a second side of the chip opposing the first side (with the eight banks 620 in between the first cluster 610A and the second cluster 610B). Accordingly, the physical design 600 may be implemented differently than the physical design 500 shown in FIG. 5.

A design parameters data structure may specify an interconnect topology (e.g., a first interconnect topology comprising text)) that is optimized for the physical design 600. For example, an interconnect topology that is optimized for the physical design 600 may have greater or fewer transaction repeaters (e.g., repeater flops, protocol buffers, or pipeline stages) between hardware (e.g., between the eight processor cores and the eight banks 620) than a default interconnect topology provided by an integrated circuit design generator. For example, an interconnect topology optimized for the physical design 600 may have greater or fewer transaction repeaters than an interconnect topology optimized for the physical design 500 shown in FIG. 5. As a result, an interconnect topology for the physical design 600 may be optimized differently than a default interconnect topology or an interconnect topology optimized for the physical design 500 shown in FIG. 5. In some implementations, optimizing the interconnect topology may reduce latency, such as by reducing the number of transaction repeaters. Accordingly, the integrated circuit design generator may apply the design parameters data structure so that the default interconnect topology that is provided by the generator is changed based on the interconnect topology that is specified in the design parameters data structure (e.g., the interconnect topology that is optimized for the physical design 600).

In some implementations, the integrated circuit may be heterogenous with respect to one or more components, such as one or more of the eight processor cores and/or one or more of the eight banks 620. For example, one or more of the eight processor cores and/or eight banks 620 (e.g., the first cluster 610A and the four banks on the first side of the chip) could include logic for implementing a first protocol (e.g., TileLink), and another one or more of the eight processor cores and/or eight banks 620 (e.g., the second cluster 610B and the four banks on the second side of the chip) could include logic for implementing a second protocol (e.g., TileLink 2c or AXI). The components associated with the protocols may be specified by the design parameters data structure, and the generator, when applying the design parameters data structure, may instantiate one or more bridges to include logic with the interconnect topology for bridging between the components associated with the different protocols.

FIG. 7 is a block diagram of an example of an integrated circuit design 700 with composable interconnect. A system may invoke an integrated circuit design generator that applies a design parameters data structure to generate the integrated circuit design 700. For example, the integrated circuit design service infrastructure 110 shown in FIG. 1 could be invoked to apply a design parameters data structure to generate the integrated circuit design 700. For example, the integrated circuit design 700 could be generated, at least part, using the process 300 shown in FIG. 3 and/or the process 400 shown in FIG. 4.

The design parameters data structure may specify hardware objects, including a first cluster 710A (including four processor cores, with each processor core having a private L2 cache), a second cluster 710B (also including four processor cores, with each processor core having a private L2 cache), a cache 720 (e.g., eight banks of L3 cache shared by the first cluster 710A and the second cluster 710B), and a first interconnect topology 730. For example, the first interconnect topology 730 may be an optimization based on the physical design 500 shown in FIG. 5 or the physical design 600 shown in FIG. 6. In some implementations, the first interconnect topology 730 may be selected from a library.

The generator may implement a second interconnect topology 740 (e.g., generator-specific interconnect topology, or default interconnect topology) to be included in the integrated circuit. The generator may apply the design parameters data structure in an append mode (as indicated by the design parameters data structure) so that the second interconnect topology 740 is changed based on the first interconnect topology 730. For example, the generator may apply the design parameters data structure to append the first interconnect topology 730 to the second interconnect topology 740. For example, the first interconnect topology 730 may comprise one or more repeater stages and appending the first interconnect topology 730 to the second interconnect topology 740 includes adding the one or more repeater stages to the second interconnect topology 740 (between the processor cores of the clusters and the cache 720). Additionally, changing the interconnect topology may include changing connections of components that attach to the interconnect topology. For example, when including the first interconnect topology 730, the generator may attach connections from components in the integrated circuit design 700 to the first interconnect topology 730 (one or more connections of which may have been previously connected to the second interconnect topology 740).

In some implementations, the integrated circuit design 700 may be heterogenous with respect to one or more components, such as one or more of the first cluster 710A, the second cluster 710B, and the cache 720. For example, the first cluster 710A and the second cluster 710B could include logic for implementing a first protocol (e.g., TileLink), and the cache 720 could include logic for implementing a second protocol (e.g., TileLink 2c or AXI). The generator, when applying the design parameters data structure, may instantiate one or more bridges to include logic with the interconnect topology for bridging between the components associated with the different protocols. For example, the generator may instantiate a bridge with the first interconnect topology 730 for bridging between the clusters (e.g., the first cluster 710A and the second cluster 710B, associated with TileLink) and the cache 720 (e.g., associated with TileLink 2c or AXI).

FIG. 8 is a block diagram of another example of an integrated circuit design 800 with composable interconnect. A system may invoke an integrated circuit design generator that applies a design parameters data structure to generate the integrated circuit design 800. For example, the integrated circuit design service infrastructure 110 shown in FIG. 1 could be invoked to apply a design parameters data structure to generate the integrated circuit design 800. For example, the integrated circuit design 800 could be generated, at least part, using the process 300 shown in FIG. 3 and/or the process 400 shown in FIG. 4.

The design parameters data structure may specify hardware objects, including a first cluster 810A (including four processor cores, with each processor core having a private L2 cache), a second cluster 810B (also including four processor cores, with each processor core having a private L2 cache), a cache 820 (e.g., eight banks of L3 cache shared by the first cluster 810A and the second cluster 810B), and a first interconnect topology 830. For example, the first interconnect topology 830 may be an optimization based on the physical design 500 shown in FIG. 5 or the physical design 600 shown in FIG. 6. In some implementations, the first interconnect topology 830 may be selected from a library.

The generator may implement a second interconnect topology (e.g., generator-specific interconnect topology, or default interconnect topology) (not shown) to be included in the integrated circuit. The generator may apply the design parameters data structure in a replace mode (as indicated by the design parameters data structure) so that the second interconnect topology is changed based on the first interconnect topology 830. For example, the generator may apply the design parameters data structure to replace the second interconnect topology with the first interconnect topology 830. For example, the first interconnect topology 830 may comprise a first cross bar having a first number of connections and the second interconnect topology may comprise a second cross bar having a second number of connections. Replacing the second interconnect topology with the first interconnect topology 830 may include replacing a second cross bar having a second number of connections with the first cross bar having the first number of connections. Additionally, changing the interconnect topology may include changing connections of components that attach to the interconnect topology. For example, when including the first interconnect topology 830, the generator may attach connections from components in the integrated circuit design 800 to the first interconnect topology 830 (one or more connections of which may have been previously connected to the second interconnect topology).

In some implementations, the integrated circuit design 800 may be heterogenous with respect to one or more components, such as one or more of the first cluster 810A, the second cluster 810B, and the cache 820. For example, the first cluster 810A and the second cluster 810B could include logic for implementing a first protocol (e.g., TileLink), and the cache 820 could include logic for implementing a second protocol (e.g., TileLink 2c or AXI). The generator, when applying the design parameters data structure, may instantiate one or more bridges to include logic with the interconnect topology for bridging between the components associated with the different protocols. For example, the generator may instantiate a bridge with the first interconnect topology 730 for bridging between the clusters (e.g., the first cluster 810A and the second cluster 810B, associated with TileLink) and the cache 820 (e.g., associated with TileLink 2c or AXI).

FIG. 9 is a block diagram of an example of a design parameters data structure 900 (e.g., a JSON file). In some implementations, a system like the integrated circuit design service infrastructure 110 shown in FIG. 1 may execute to access the design parameters data structure 900. In some implementations, the system may execute to compose the design parameters data structure 900. For example, the design parameters data structure 900 could be used in the process 300 shown in FIG. 3. For example, the design parameters data structure 900 could be accessed and/or composed, at least part, using the process 400 shown in FIG. 4. The design parameters data structure may comprise design parameters that specify one or more definitions for a hardware object which may be defined in a hierarchy (e.g., specified as one or more objects in the JSON file which may be mapped in a hierarchy). The design parameters data structure may also comprise design parameters that specify one or more instances of the hardware object (e.g., specified as one or more instances of the one or more objects in the JSON file which may be mapped in the hierarchy). Additionally, each definition may have one or more child definitions. This may permit modifying definitions of objects at multiple levels. For example, a definition may specify an interconnect topology, a processor core, a cache, or a cluster (e.g., including processor cores and their private L2 caches), and a child to the definition may override some characteristic of the interconnect topology, the processor core, the cache, or the cluster. Also, each definition may have one or more instances at various levels. For example, instances of the definition could be instances of the interconnect topology, the processor core, the cache, or the cluster.

The definition and/or the instances may be modified, such as by the integrated circuit design service infrastructure 110 shown in FIG. 1. Modifying a definition may permit modification of definitions and instances that are children to the definition. In other words, modifying a definition may override values or parameters of definitions and instances that are children to the definition. Additionally, values or parameters of individual instances may be modified, such as to include information that is specific to an SoC implementation (e.g., a value that indicates one or more addresses associated with the instance when implemented on the SoC, such as an address for routing a memory transaction, and/or a value that indicates an identifier for the instance when implemented on the SoC, such as a central processing unit (CPU) identifier). For example, one instance could be modified without modifying other instances and without modifying the definition. Thus, definitions and instances may each be modifiable.

For example, the design parameters data structure 900 may specify a first definition 905 that defines characteristics for a hardware object, such as characteristics for a processor core. The first definition 905 may be a base definition or parent for one or more child definitions, such as a second definition 910 and a third definition 915. The second definition 910 and the third definition 915 may override one or more characteristics of the first definition 905 without affecting one another and without affecting first definition 905. For example, the second definition 910 may modify a cache size associated with the processor core, and the third definition 915 may modify a tag associated with the processor core, without the modification by the second definition 910 affecting the first definition 905 or the third definition 915, and without the modification by the third definition 915 affecting the first definition 905 or the second definition 910. Further, the one more definitions may have child instances, such as the second definition 910 having child instances 920A through 920D, and the third definition 915 having child instances 925A through 925D. An instance may be a specific object defined by each their parent definition of the instance. For example, the instances 920A through 920D may be instances of processor cores (as defined by the first definition 905) with a modified cache size (as defined by the second definition 910), and the instances 925A through 925D may be instances of processor cores (as defined by the first definition 905) with a modified tag (as defined by the third definition 915). In some implementations, the first definition 905 could also have child instances (e.g., without a child definition between the first definition 905 and the instance).

Additionally, instances in the design parameters data structure 900 may be modified to include information that is specific to an implementation in an ASIC or an SoC, such as a base address and/or an identifier. For example, instance 920A may be modified to include a base address 1 and/or an identifier 1, instance 920B could be modified to include a base address 2 and/or an identifier 2, and so forth. As a result, the instances may be modified to uniquely include the base addresses and/or identifiers that may be specific to an ASIC or an SoC. In some implementations, the design parameters data structure 900 may specify heterogenous components, such as a first component associated with a first protocol (e.g., TileLink) and a second component associated with a second protocol (e.g., TileLink 2c or AXI). For example, the second definition 910 could indicate components using logic associated with a first protocol, while the third definition 915 could indicate components using logic associated with a second protocol. A generator, applying the design parameters data structure 900, may instantiate a bridge to enable the heterogeneous components to communicate, such as with the interconnect topology, which could be implemented by a cross bar.

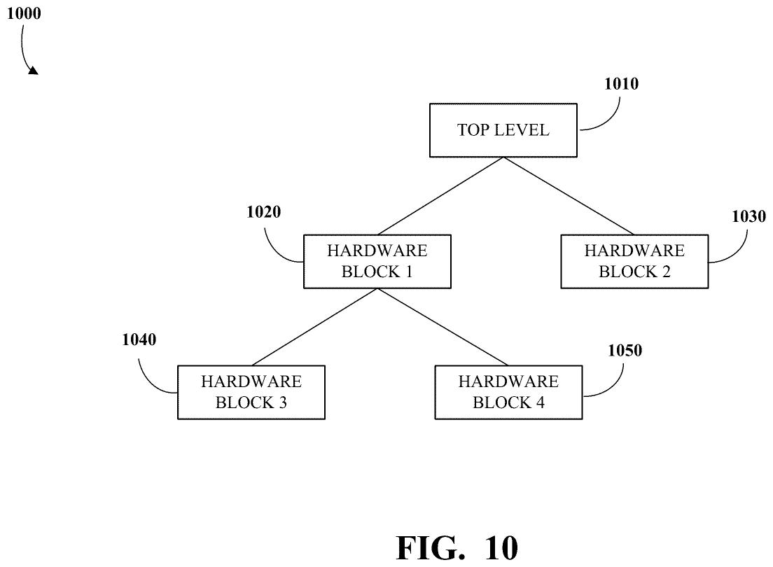

FIG. 10 is a block diagram of an example of a hierarchy 1000 that may be specified (e.g., defined) by a design parameters data structure (e.g., a JSON file). For example, the hierarchy 1000 may be specified by a design parameters data structure used in the process 300 shown in FIG. 3 and/or the process 400 shown in FIG. 4. For example, the hierarchy 1000 may be specified by the design parameters data structure 900 shown in FIG. 9. The hierarchy 1000 may specify a map of instances (with connections between instances) in the design parameters data structure as they are located in a physical hierarchy. For example, the hierarchy 1000 may be specified in one or more hardware blocks used to generate one or more RTL modules (e.g., Verilog modules) in a design hierarchy for a physical layout of chip.

For example, a design parameters data structure may specify an overarching parent 1010 at a top level. For example, the parent 1010 could correspond to an instance of a cluster of processor cores. The parent 1010 may have one or more child modules in the hierarchy, such as a first hardware block 1020 and a second hardware block 1030. For example, the first hardware block 1020 could correspond to an instance of a processing core in the cluster, and the second hardware block 1030 could correspond to an instance of a trace encoder in the cluster. The one or more child modules could also have one or more child modules, and so forth, such as the first hardware block 1020 having child modules including a third hardware block 1040 and a fourth hardware block 1050. For example, the third hardware block 1040 could correspond to a private L2 cache associated with the processing core, and the fourth hardware block 1050 could correspond to a prefetcher associated with the processing core. The hardware blocks may correspond to instances of hardware objects in the design parameters data structure.

Accordingly, the design parameters data structure may permit arranging (and rearranging) instances in a design hierarchy. The arrangement may be propagated to an integrated circuit design generator that applies the design parameters data structure to generate the design, with connections between instances, according to the hierarchy. For example, the integrated circuit design service infrastructure 110 shown in FIG. 1 could be invoked to apply a design parameters data structure to generate a design according to the hierarchy 1000. Thus, the design parameters data structure permits controlling the design hierarchy.

In some implementations, a design parameters data structure may be used to create a cluster (such as for an ASIC or an SoC) by placing instances that are associated with the cluster into a hierarchy corresponding to the cluster. For example, to implement a design having four clusters, each of the four clusters may be defined in the design parameters data structure, and instances belonging to each cluster (e.g., processing cores) may be mapped to the cluster in a hierarchy.

In a first aspect, the subject matter described in this specification can be embodied in a method that includes: accessing a design parameters data structure that specifies a first interconnect topology to be included in an integrated circuit, wherein the first interconnect topology is designed to route a transaction from a transaction source; and invoking an integrated circuit design generator, wherein the invoked integrated circuit design generator applies the design parameters data structure to generate an integrated circuit design by changing a second interconnect topology specified by the integrated circuit design generator based on the first interconnect topology. In some implementations, the integrated circuit design generator is operable to append the first interconnect topology to the second interconnect topology. In some implementations, appending the first interconnect topology to the second interconnect topology comprises adding a repeater stage in the integrated circuit design for routing the transaction. In some implementations, the integrated circuit design generator is operable to replace the second interconnect topology with the first interconnect topology. In some implementations, replacing the second interconnect topology with the first interconnect topology comprises replacing, in the integrated circuit design, a second cross bar having a second number of connections with a first cross bar having a first number of connections. In some implementations, the method further comprises selecting the first interconnect topology from a library. In some implementations, changing the second interconnect topology based on the first interconnect topology may include changing a connection of a component from the second interconnect topology to the first interconnect topology. In some implementations, the integrated circuit design includes a hardware construction language expression of the second interconnect topology changed by the first interconnect topology. In some implementations, the integrated circuit design generator executes a Scala program, and the integrated circuit design comprises a flexible intermediate representation for register-transfer level (FIRRTL) data structure. In some implementations, the method further includes compiling the integrated circuit design to generate Verilog.

In a second aspect, the subject matter described in this specification can be embodied in a method that includes: accessing a design parameters data structure that specifies a definition for a hardware object and a plurality of instances of the hardware object to be included in an integrated circuit, wherein modifying the definition for the hardware object is operable to modify an instance of the hardware object when executed; and invoking an integrated circuit design generator, wherein the invoked integrated circuit design generator applies the design parameters data structure to generate an integrated circuit design including the plurality of instances of the hardware object. In some implementations, the method further includes modifying an instance of the hardware object to include a value for the instance that is specific to an implementation on a system on a chip. In some implementations, the value indicates a base address or identifier associated with the instance when implemented on the system on a chip. In some implementations, the method includes arranging the plurality of instances in a hierarchy and comprising at least one instance that is a parent and at least one instance that is a child of the parent. In some implementations, the definition defines a hardware object comprising a processor core and a private L2 cache associated with the processor core. In some implementations, the plurality of instances of the hardware object represents a plurality of processing cores, and the plurality of processing cores corresponds to a cluster. In some implementations, the definition defines a hardware object comprising an interconnect topology, wherein the interconnect topology is configured to route a transaction from a transaction source to a sink.

In a third aspect, the subject matter described in this specification can be embodied in a method that includes: accessing a design parameters data structure that specifies a definition for a first interconnect topology and a plurality of instances of the first interconnect topology to be included in an integrated circuit, wherein a first interconnect topology is designed to route a transaction from a transaction source, wherein modifying the definition for the first interconnect topology is operable to modify an instance of the first interconnect topology when executed; and invoking an integrated circuit design generator, wherein the invoked integrated circuit design generator applies the design parameters data structure to generate an integrated circuit design by changing a plurality of instances of a second interconnect topology specified by the integrated circuit design generator based on the plurality of instances of the first interconnect topology. In some implementations, the integrated circuit design generator is operable to append the plurality of instances of the first interconnect topology to the plurality of instances of the second interconnect topology. In some implementations, the integrated circuit design generator is operable to replace the plurality of instances of the second interconnect topology with the plurality of instances of the first interconnect topology. In some implementations, the method further includes modifying an instance of the first interconnect topology to include a value for the instance that is specific to an implementation on a system on a chip. In some implementations, the value indicates a base address or identifier associated with routing the transaction from the transaction source.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent arrangements.

What is claimed is:

1. A method comprising:
accessing a design parameters data structure that specifies a first interconnect topology to be included in an integrated circuit, wherein the first interconnect topology is designed to route a transaction from a transaction source; and
generating an integrated circuit design by invoking an integrated circuit design generator, wherein the integrated circuit design generator applies the design parameters data structure to generate the integrated circuit design by changing a second interconnect topology specified by the integrated circuit design generator based on the first interconnect topology.

2. The method of claim 1, wherein the integrated circuit design generator is operable to append the first interconnect topology to the second interconnect topology.

3. The method of claim 1, wherein the integrated circuit design generator is operable to replace the second interconnect topology with the first interconnect topology.

4. The method of claim 1, further comprising selecting the first interconnect topology from a library.

5. The method of claim 1, wherein changing the second interconnect topology based on the first interconnect topology comprises changing a connection of a component from the second interconnect topology to the first interconnect topology.

6. The method of claim 1, wherein the integrated circuit design includes a hardware construction language expression of the second interconnect topology changed by the first interconnect topology.

7. The method of claim 1, wherein the integrated circuit design generator executes a Scala program, and wherein the integrated circuit design comprises a flexible intermediate representation for register-transfer level data structure, and further comprising compiling the integrated circuit design to generate Verilog.

8. The method of claim 1, wherein the integrated circuit design generator instantiates a bridge for routing the transaction from the transaction source associated with a first protocol to a transaction sink associated with a second protocol.

9. A method comprising:
accessing a design parameters data structure that specifies a definition for a hardware object and a plurality of instances of the hardware object to be included in an integrated circuit, wherein modifying the definition for the hardware object modifies an instance of the hardware object; and
generating an integrated circuit design by invoking an integrated circuit design generator, wherein the integrated circuit design generator applies the design parameters data structure to generate the integrated circuit design including the plurality of instances of the hardware object.

10. The method of claim 9, further comprising modifying an instance of the hardware object to include a value for the instance that is specific to an implementation on a system on a chip.

11. The method of claim 9, further comprising:
arranging the plurality of instances in a hierarchy comprising at least one instance that is a parent and at least one instance that is a child of the parent.

12. The method of claim 11, wherein the definition defines a hardware object comprising a processor core and a private Level 2 (L2) cache associated with the processor core.

13. The method of claim 12, wherein the plurality of instances of the hardware object represents a plurality of processing cores, and wherein the plurality of processing cores corresponds to a cluster.

14. The method of any of claim 9, wherein the definition defines a hardware object comprising an interconnect topology, wherein the interconnect topology is configured to route a transaction from a transaction source to a sink.

15. The method of claim 14, wherein the integrated circuit design generator instantiates a bridge for routing a transaction from a transaction source associated with a first protocol to a transaction sink associated with a second protocol.

16. A method comprising:
accessing a design parameters data structure that specifies a definition for a first interconnect topology and a plurality of instances of the first interconnect topology to be included in an integrated circuit, wherein a first interconnect topology is designed to route a transaction from a transaction source, wherein modifying the definition for the first interconnect topology modifies an instance of the first interconnect topology; and
generating an integrated circuit design by invoking an integrated circuit design generator, wherein the integrated circuit design generator applies the design parameters data structure to generate the integrated circuit design by changing a plurality of instances of a second interconnect topology specified by the integrated circuit design generator based on the plurality of instances of the first interconnect topology.

17. The method of claim 16, wherein the integrated circuit design generator is operable to append the plurality of instances of the first interconnect topology to the plurality of instances of the second interconnect topology.

18. The method of claim 16, wherein the integrated circuit design generator is operable to replace the plurality of instances of the second interconnect topology with the plurality of instances of the first interconnect topology.

19. The method of claim 16, further comprising modifying an instance of the first interconnect topology to include a value for the instance that is specific to an implementation on a system on a chip.

20. The method of claim 16, wherein the integrated circuit design generator instantiates a bridge for routing the transaction from the transaction source associated with a first protocol to a transaction sink associated with a second protocol.
